(19) United States
(12) Patent Application Publication
(10) Pub. No.: US 2009/0169294 A1
(43) Pub. Date: Jul. 2, 2009

(54) Reinforcing Bar Connector

(75) Inventor: Mituo Nakamura, Fukuoka (JP)

Correspondence Address: FITCH, EVEN, TABIN & FLANNERY, P. O. BOX 18415, WASHINGTON, DC, 20036, US

(73) Assignees: TamaHome Co., Ltd., Tokyo (JP); Mituo Nakamura, Dazaifu-shi (JP)

(21) Appl. No.: 12/086,777

(22) PCT Filed: Oct. 30, 2006
(86) PCT No.: PCT/JP2006/321650

§ 371 Date: Jun. 19, 2008

(30) Foreign Application Priority Data
Dec. 22, 2005 (JP) 2005-370827

(51) Int. Cl. F16B 7/00; F16B 1/00; F16B 7/18; F16B 7/22

(52) U.S. Cl. 403/287

(57) ABSTRACT

A reinforcing bar connector is capable of connecting reinforcing bars easily and in a short time without using a screw-tightening tool. The reinforcing bar connector has a reinforcing bar holding section having a female screw thread part screwed on a male screw part on the outer periphery of the reinforcing bar; a flat, plate-shaped engaging section extending in the direction of a center axis C from the reinforcing bar holding section; a locking projection provided on the engaging section; and a locking hole provided in the engaging section and allowing for engagement of the locking projection of another reinforcing bar connector to the locking hole. A stopper for preventing the locking projection from falling out of the locking hole is provided at a distal end of the locking projection. An attaching hole having an inner diameter through which the stopper can pass is formed next to the engaging hole. A communicating part through which the locking projection can pass is formed between the attaching hole and the locking hole.

### FIELD OF THE INVENTION

The present invention relates to a reinforcing bar connector used for connecting a reinforcing bar which is used in reinforcing a concrete structure.

### BACKGROUND ART

Conventionally, various kinds of connectors have been developed as means for connecting a reinforcing bar used in building a concrete structure (see Patent Documents 1 and 2, for example). In the connector described in Patent Document 1, end portions of two reinforcing bars are inserted into both ends of a connecting member, respectively, and a nut screwed onto an outer periphery of each end of the connecting member is tightened to fix the end portions of the reinforcing bars to the connecting member, thereby connecting the reinforcing bars to each other. In the reinforcing bar connector described in Patent Document 2, end portions of two reinforcing bars are inserted into both ends of a sleeve and screwed in the sleeve using a screw thread formed on an outer periphery of the reinforcing bars while nuts screwed onto the reinforcing bars are tightened to fix the end portions of the reinforcing bars to the sleeve, thereby connecting the reinforcing bars to each other.

Patent Document 1: Japanese Unexamined Patent Publication No. H07-173884

Patent Document 2: Japanese Utility Model Registration No. 3099015

### DISCLOSURE OF THE INVENTION

### Problems to be Solved by the Invention

In the connector described in Patent Document 1, it is necessary to insert end portions of reinforcing bars into both ends of the connecting member and to tighten the two nuts using a tool such as a wrench. Therefore, the process is troublesome and also takes a long time for the operation. Similarly, in the reinforcing bar connector described in Patent Document 2, after end portions of reinforcing bars are screwed into both ends of the sleeve, the two nuts have to be tightened with a wrench or other tools, which renders the process troublesome and needs a long time for the operation as well.

An object of the present invention is to provide a reinforcing bar connector capable of connecting reinforcing bars easily and in a short time without using a screw tightening tool.

### Means for Solving the Problems

A reinforcing bar connector of the present invention comprises a reinforcing bar holding section having a female screw thread part which is screwed onto a male screw part formed on an outer periphery of a reinforcing bar, an engaging section extending from the reinforcing bar holding section in a direction of a center axis, a locking projection protruding from the engaging section in a direction crossing the center axis, and a locking hole or a locking recess formed in the engaging section between the locking projection and the reinforcing bar holding section to detachably receive the locking projection of another reinforcing bar connector having the same shape as said reinforcing bar connector.

Two reinforcing bar connectors of the present invention are prepared. One end portion of each of two reinforcing bars to be connected is screwed into a reinforcing bar holding section of each of the reinforcing bar connectors. After the two reinforcing bar connectors are fixed on the end portions of the reinforcing bars, respectively, engaging sections extending from the reinforcing bar holding sections in a direction of a center axis are positioned to oppose each other. Then, a locking projection of one of the reinforcing bar connectors is set into a locking hole or a locking recess of the other reinforcing bar connector, and vice versa, so that the engaging sections are connected to each other. Thus, the two reinforcing bars are connected with the two reinforcing bar connectors. The end portion of the reinforcing bar can be fixed to the reinforcing bar holding section simply by screwing a male screw part formed on an outer periphery of the reinforcing bar into a female screw thread part of the reinforcing bar holding section, and the locking projection can be fixed to the engaging section simply by inserting or fitting the locking projection into the locking hole or the locking recess. Therefore, the reinforcing bars can be easily connected in a short time without using a screw tightening tool.

Here, preferably, the reinforcing bar connector may be provided with a stopper formed on the locking projection for preventing the locking projection from falling out of the locking hole, an attaching hole through which the stopper can pass formed next to the locking hole, and a communicating part through which the locking projection can pass formed between the attaching hole and the locking hole. In this structure, after the locking projections of the two reinforcing bar connectors are inserted into the attaching holes of the reinforcing bar connectors with respect to one another, the reinforcing bar connectors are moved so that the locking projections are moved from the attaching holes to the locking holes through the communicating parts. Then, the locking projections are fitted in the locking holes and engaged therewith by the stopper so that they cannot be detached. Thus, the reinforcing bar connectors can be connected in a securer state with the simple connecting operation.

In this case, by further providing an inserting member for plugging the attaching hole, it is possible to prevent the two reinforcing bar connectors connected to each other by engaging the locking projection with the locking hole from separating if the locking projection inadvertently moves toward the attaching hole. Thus, the reinforcing bar connectors can be securely connected.

### EFFECTS OF THE INVENTION

According to the present invention, reinforcing bars can be quickly connected in a simple manner without using a screw tightening tool.

### BRIEF DESCRIPTION OF THE DRAWINGS

FIG. 1A is a side view illustrating a reinforcing bar connector of an embodiment of the present invention;

FIG. 1B is a front view of the reinforcing bar connector of FIG. 1A;

FIG. 2 is a plan view of the reinforcing bar connector shown in FIGS. 1A and 1B;

FIG. 3 is a sectional view taken along the line A-A in FIG. 2;

FIG. 4A is a view illustrating a use of the reinforcing bar connector shown in FIGS. 1A and 1B;

FIG. 4B is a view illustrating a use of the reinforcing bar connector shown in FIGS. 1A and 1B;

FIG. 4C is a view illustrating a use of the reinforcing bar connector shown in FIGS. 1A and 1B;

FIG. 5 is a view illustrating a connecting state with the reinforcing bar connector shown in FIGS. 1A and 1B;

FIG. 6A is a plan view illustrating a reinforcing bar connector of another embodiment of the present invention;

FIG. 6B is a front view illustrating the reinforcing bar connector of FIG. 6A; and

FIG. 6C is a bottom view illustrating the reinforcing bar connector of FIG. 6A.

### DESCRIPTION OF REFERENCE NUMERALS AND SYMBOLS

10, 10x, 10y, 20: reinforcing bar connector
11, 11x, 11y: reinforcing bar
11a: male screw part
13, 23: reinforcing bar holding section
13a: flat part
13b, 23b: female screw thread part
14, 24: engaging section
14a: upper face
14b: lower face
14w: width
15: locking projection
15a: stopper
16: locking hole
17: attaching hole
18: communicating part
19: inserting member
23a: outer peripheral surface
24a: upper face
24b: lower face
24c: side face
C: center axis

### BEST MODE FOR CARRYING OUT THE INVENTION

Embodiments of the present invention are explained below with reference to the drawings.

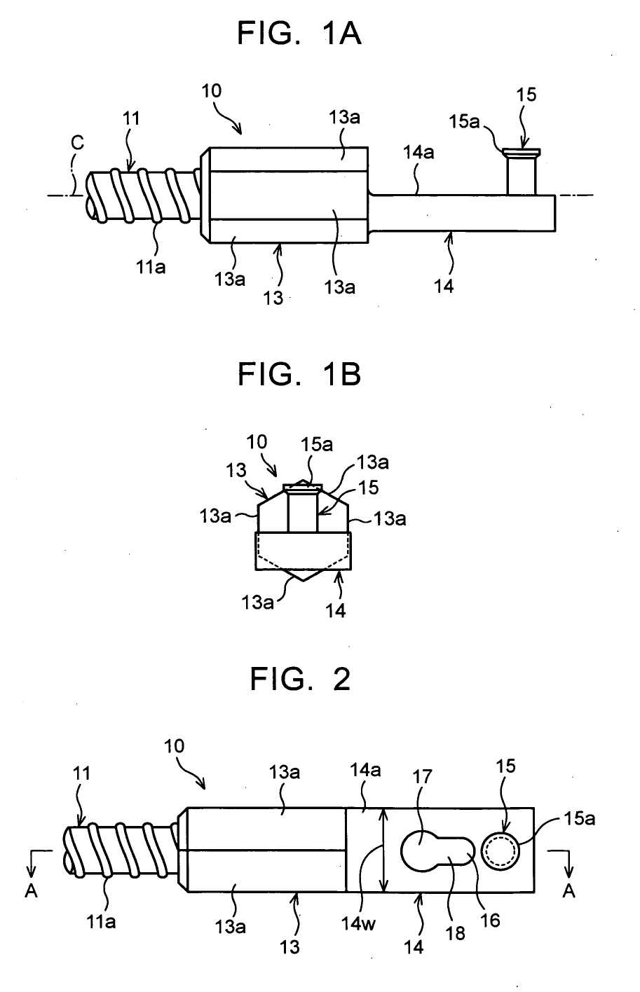

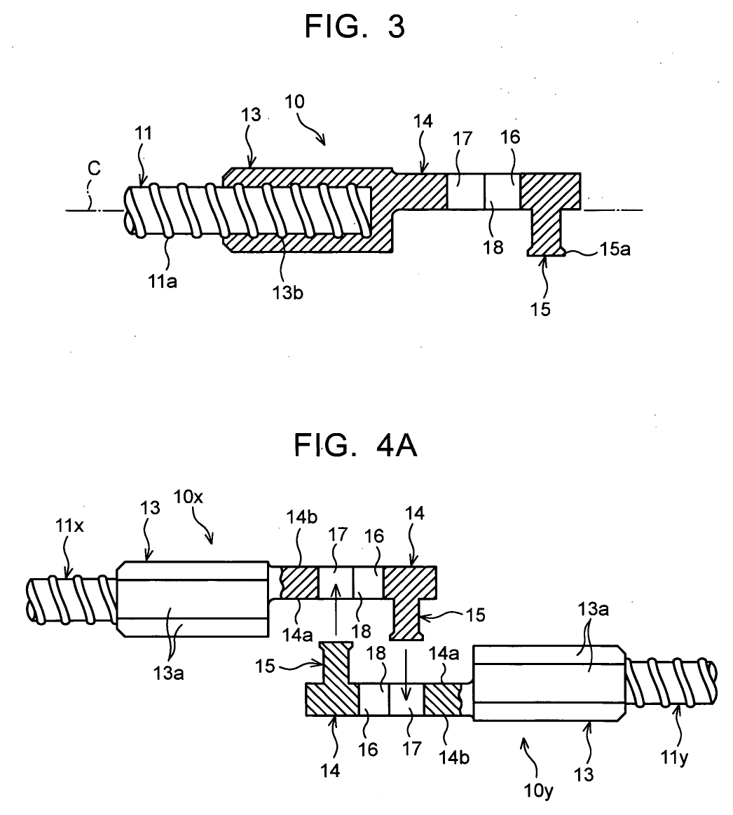

As shown in FIGS. 1A, 1B, 2 and 3, a reinforcing bar connector 10 of the present embodiment includes a reinforcing bar holding section 13 having a female screw thread part 13b which is screwed onto a male screw part 11a formed on an outer periphery of a reinforcing bar 11; an engaging section 14 extending from the reinforcing bar holding section 13 in a direction of a center axis C; a locking projection 15 protruding from the engaging section 14 in a direction crossing the center axis C; and a locking hole 16 formed in the engaging section 14 between the locking projection 15 and the reinforcing bar holding section 13 to detachably receive the locking projection 15 of another reinforcing bar connector 10 having the same shape as said reinforcing bar connector 10. A width 14w of the engaging section 14 is substantially the same as the maximum external diameter of the reinforcing bar holding section 13, and an upper face 14a of the engaging section 14 is formed at a position corresponding to the center axis C.

Furthermore, a flange-shaped stopper 15a is provided on a distal end of the locking projection 15 in order to prevent the locking projection 15 having a column shape from falling out of the locking hole 16. An attaching hole 17 which has an internal diameter allowing the stopper 15a to pass therethrough is opened next to the locking hole 16. A communicating part 18 which has a width allowing the locking projection 15 to pass therethrough is formed between the attaching hole 17 and the locking hole 16. An internal diameter of the locking hole 16 is set so as to be larger than an external diameter of the locking projection 15 and smaller than an external diameter of the stopper 15a. In addition, six flat parts 13a are provided on an outer periphery of the reinforcing bar holding section 13 to form a regular hexagonal column.

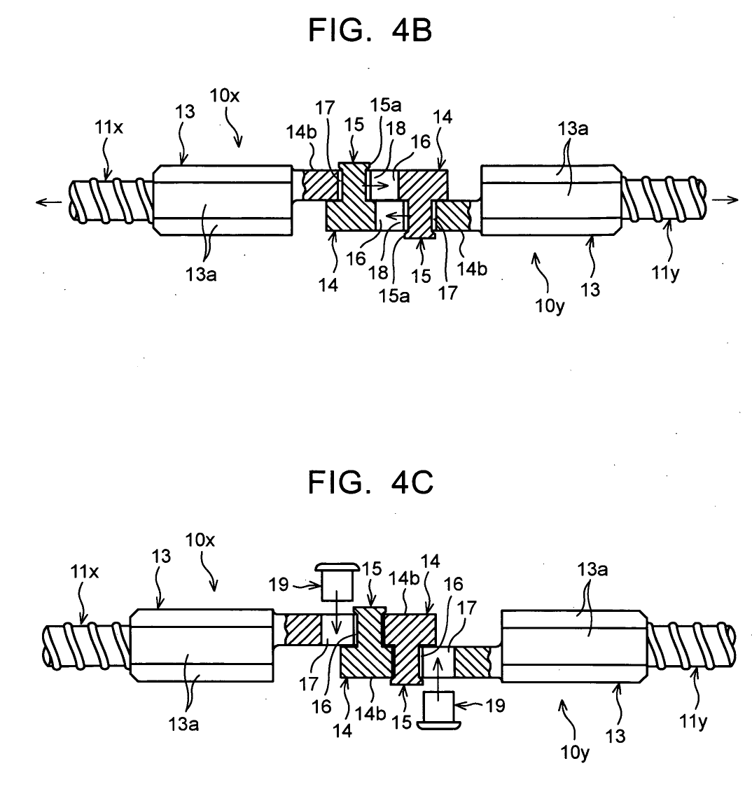

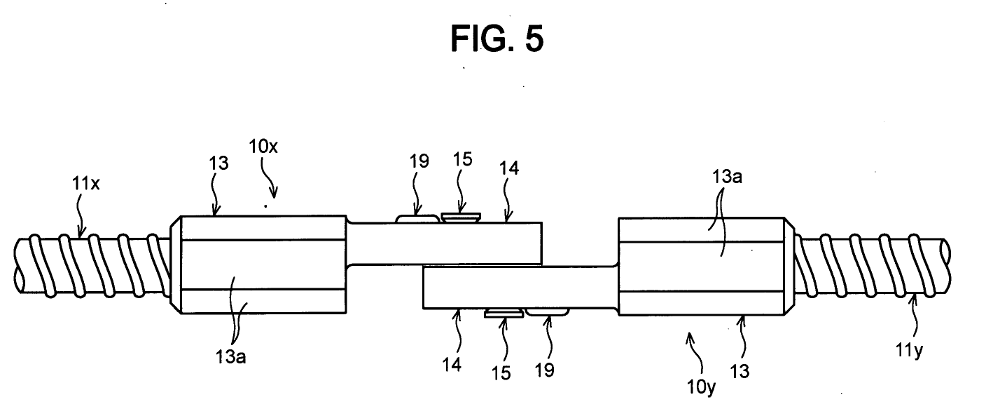

Here, with reference to FIGS. 4A, 4B, 4C and 5, a use of the reinforcing bar connector 10 is explained below. First, as shown in FIG. 4A, two reinforcing bar connectors 10x and 10y are prepared. One end portion of each of two reinforcing bars 11x and 11y to be connected is inserted and screwed into the female screw thread part 13b of the reinforcing bar connecting section 13 of each of the reinforcing bar connectors 10x and 10y. After the two reinforcing bar connectors 10x and 10y are fixed on the end portions of the reinforcing bars 11x and 11y, respectively, the engaging sections 14 extending from the reinforcing bar holding sections 14 are positioned so that the upper faces 14a oppose each other. Then, the two engaging sections 14 are brought close to each other, and the locking projections 15 are inserted into the attaching holes 17, respectively, resulting in the state shown in FIG. 4B. Here, the locking projections 15 are pushed in to such an extent that the stoppers 15a expose from lower faces 14b of the engaging sections 14, or that the upper faces 14a of the two engaging sections 14 are brought into contact with each other.

Next, while maintaining the state shown in FIG. 4B, the two reinforcing bar connectors 10x and 10y are moved toward a separating direction. Then, the two locking projections 15 move from the attaching holes 17 into the locking holes 16 through the communicating parts 18, respectively, leading to the state shown in FIG. 4C. In this manner, the locking projections 15 are fixed into the locking holes 16 so that they cannot be detached. Subsequently, two inserting members 19 are fitted in the attaching holes 17 to plug the attaching holes 17, resulting in the state shown in FIG. 5, which is the end of the connecting operation. Note that the inserting members 19 may be omitted if unnecessary.

Thus, by connecting the engaging sections 14 to each other by inserting the locking projection 15 of the reinforcing bar connector 10x on one reinforcing bar into the locking hole 16 of the reinforcing bar connector 10y on the other reinforcing bar, the two reinforcing bars 11x and 11y are connected with the two reinforcing bar connectors 10x and 10y. The end portions of the reinforcing bars 11x and 11y are fixed on the reinforcing bar holding sections 13 simply by screwing the male screw parts 11a formed on the outer periphery of the end portions into the female screw thread parts 13b in the reinforcing bar holding sections 13. Moreover, the locking projections 15 can be fixed to the engaging sections 14 by inserting the locking projections 15 into the locking holes 16 through the attaching holes 17 and the communicating parts 18. Accordingly, the two reinforcing bars 11x and 11y can be easily connected in a short time without using a screw tightening tool such as a wrench.

As described above, the stopper 15a is provided on the distal end of the locking projection 15 for preventing the locking projection 15 from falling out of the locking hole 16; the attaching hole 17 allowing the stopper 15a to pass therethrough is opened next to the locking hole 16; and the communicating part 18 allowing the locking projection 15 to pass therethrough is provided between the attaching hole 17 and the locking hole 16. Accordingly, after the locking projection 15 of the reinforcing bar connectors 10x is inserted into the attaching hole 17 of the reinforcing bar connectors 10y while the locking projection 15 of the reinforcing bar connectors 10y is inserted into the attaching hole 17 of the reinforcing bar connectors 10x, the reinforcing bar connectors 10x and 10y are moved toward a separating direction. By this simple operation, the locking projections 15 inside the attaching holes 17 move into the locking holes 16 through the communicating portions 18 and are engaged with the locking holes 16 by the stoppers 15a, respectively, so that they cannot be detached. Thus, the reinforcing bar connectors can be connected in a secure state with the extremely simple connecting operation, and the operability at a construction site is excellent as well.

With the inserting member 19 for plugging the attaching hole 17 after the locking projection 15 is moved into the locking hole 16, the locking projection 15 is free from inadvertent movement toward the attaching hole 17, which may separate the two reinforcing bar connectors 10x and 10y attached to each other with the engagement between the locking projection 15 and the locking hole 16. Therefore, it is possible to obtain a highly stable connecting state. Moreover, since the tensile force applied to the reinforcing bars 11x and 11y is supported by the engaging structure of the locking projection 15 and the locking hole 16, the reinforcing bars 11x and 11y can be stably supported.

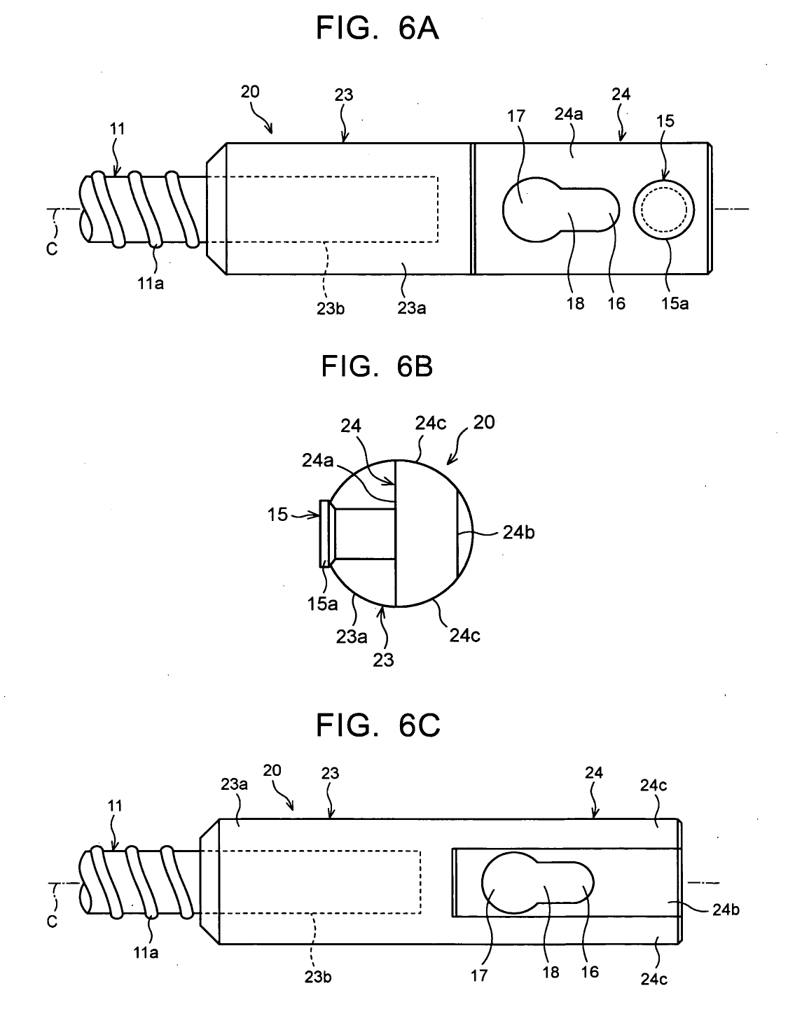

Next, with reference to FIGS. 6A, 6B and 6C, another embodiment of the present invention is explained below. Note that, in FIGS. 6A, 6B and 6C, the members bearing the same reference numerals as those used in FIGS. 1A to 5 have the same functions and effects as the members of the above-described reinforcing bar connector 10, and the explanation is omitted.

As shown in FIGS. 6A, 6B and 6C, a reinforcing bar connector 20 of this embodiment includes a reinforcing bar holding section 23 having a female screw thread part 23b which is screwed onto a male screw part 11a formed on an outer periphery of a reinforcing bar 11; an engaging section 24 extending from the reinforcing bar holding section 23 in a direction of a center axis C; a locking projection 15 protruding from the engaging section 24 in a direction crossing the center axis C; and a locking hole 16 formed in the engaging section 24 between the locking projection 15 and the reinforcing bar holding section 23 to detachably receive the locking projection 15 of another reinforcing bar connector 20 having the same shape as said reinforcing bar connector 20.

An outer peripheral surface 23a of the reinforcing bar holding section 23 has a column shape, and both side faces 24c of the engaging section 24 are formed to have the same curvature with the outer peripheral surface 23a and continue to the outer peripheral surface 23a. An upper face 24a of the engaging section 24 is formed at a position corresponding to the center axis C, and a lower face 24b is formed to be flat and slightly retract from the outer peripheral surface 23a of the reinforcing bar holding section 23. The use of the reinforcing bar connector 20 is similar to the use of the reinforcing bar connector 10 described above. By following the process illustrated in FIGS. 4A, 4B and 4C, reinforcing bars can be easily connected to each other.

In the reinforcing bar connector 20, the outer peripheral surface 23a of the reinforcing bar holding section 23 has a column shape, and the both side faces 24c of the engaging section 24 extending from the reinforcing bar holding section 23 are also formed to be a part of the same column shape. Accordingly, when the two reinforcing bar connectors 20 are connected, the both side faces 24c of the two engaging sections 24 form a part of a continuous column shape with a contacting portion of the upper faces 24a of the engaging sections 24 as a border. Thus, a whole shape ranging from one reinforcing bar holding section 23 via the two engaging sections 24 to another reinforcing bar holding section 23 is a substantially column shape with a relatively smooth surface. Therefore, it is possible to prevent the reinforcing bar connector 20 from touching and scratching other members or damaging other members. The other functions and effects of the reinforcing bar connector 20 are the same as those of the reinforcing bar connector 10.

### INDUSTRIAL APPLICABILITY

The reinforcing bar connector according to the present invention is broadly applicable to the construction industry as a reinforcing bar connector used in a concrete structure.

1. A reinforcing bar connector comprising:
a reinforcing bar holding section having a female screw thread part which is screwed onto a male screw part formed on an outer periphery of a reinforcing bar,
an engaging section extending from the reinforcing bar holding section in a direction of a center axis,
a locking projection protruding from the engaging section in a direction crossing the center axis, and
a locking hole or a locking recess formed in the engaging section between the locking projection and the reinforcing bar holding section to detachably receive the locking projection of another reinforcing bar connector having the same shape as said reinforcing bar connector.

2. The reinforcing bar connector according to claim 1, further comprising:
a stopper formed on the locking projection for preventing the locking projection from falling out of the locking hole,
an attaching hole through which the stopper can pass formed next to the locking hole, and
a communicating part through which the locking projection can pass formed between the attaching hole and the locking hole.

3. The reinforcing bar connector according to claim 2, further comprising an inserting member for plugging the attaching hole.
